(19) United States
(12) Patent Application Publication
(10) Pub. No.: US 2022/0405658 A1
(43) Pub. Date: Dec. 22, 2022

(54) MACHINE LEARNING ASSISTED AUTOMATION OF WORKFLOWS BASED ON OBSERVATION OF USER INTERACTION WITH OPERATING SYSTEM PLATFORM FEATURES

(71) Applicant: MICROSOFT TECHNOLOGY LICENSING, LLC, Redmond, WA (US)

(72) Inventors: Sarjana Sheth MITRA, Yarrow Point, WA (US); Ieva BURK, Redmond, WA (US); Mythili MURUGANATHAN, Redmond, WA (US)

(21) Appl. No.: 17/733,172

(22) Filed: Apr. 29, 2022

Related U.S. Application Data
(60) Provisional application No. 63/211,702, filed on Jun. 17, 2021.

(51) Int. Cl. G06Q 10/06; G06N 20/00

(52) U.S. Cl. CPC G06Q 10/0633; G06N 20/00

(57) ABSTRACT

Technologies are disclosed for machine learning assisted automation of workflows based on observation of user interaction with operating system (OS) platform features. User interaction data is collected that defines the activity of a user with respect to platform features provided by an OS. The user interaction data is provided to a trained machine learning model that is configured to identify a workflow for performing a task based on the user interaction data. If the trained machine learning model identifies a relevant workflow, a user interface (UI) can be presented to the user that includes data identifying the workflow selected by the trained machine learning model. The UI can also include an element which, when selected, will cause the computing device to execute the workflow selected by the trained machine learning model based on the user interaction data.

### CROSS-REFERENCE TO RELATED APPLICATIONS

This application claims the benefit of and priority to U.S. provisional patent application No. 63/211,702, filed Jun. 17, 2021, and entitled “Machine Learning Assisted Automation of Workflows Based on Observation of User Interaction with Operating System Platform Features,” the contents of which are incorporated herein by reference in their entirety.

### BACKGROUND

There are many types of workflows that users routinely perform on computing devices to accomplish desired tasks. For example, a user might copy data describing an event (e.g., date, time, location, and details) to an operating system (“OS”)-provided clipboard. In order to create a new event in their calendar, the user might then locate and launch a calendar application on their computing device, manually create a new event on the appropriate date in the correct calendar, and paste the contents of the clipboard (i.e., the meeting information) into the newly created calendar event. A user might repeat these same operations many times a day to create different calendar events.

When performing tasks like the one described above, users commonly perform many different user input operations (e.g., mouse cursor movement and selection operations) and initiate multiple context switches between different applications. As a result, completing these types of tasks can be inefficient. Consequently, computing resources such as processor cycles, memory, and network bandwidth might not be utilized efficiently. Moreover, repeated performance of certain tasks can be frustrating for users, particularly if the same tasks have to be performed multiple times per day, which can lead to reduced productivity and inefficient use of computing resources.

It is with respect to these and other technical challenges that the disclosure made herein is presented.

### SUMMARY

Technologies are disclosed for machine learning assisted automation of workflows based on observation of user interaction with OS platform features. Through implementations of the disclosed technologies, a trained machine learning model can be utilized to identify and instantiate relevant workflows for automating tasks based upon observing user interaction with OS platform features. This can result in the completion of repetitive tasks commonly performed by users using shorter and/or more computationally efficient workflows and simpler operations, which can result in the conservation of computing resources such as those described above. Additionally, these benefits can be achieved by an OS without requiring applications to be modified in order to provide the disclosed functionality. Other technical benefits not specifically mentioned herein can also be realized through implementations of the disclosed subject matter.

In order to realize the technical benefits mentioned briefly above, and potentially others, user interaction with one or more features (which might be referred to herein as “OS platform features,” “OS-provided features,” or simply “features”) provided by an OS can be observed. User interaction data defining the user's interaction with the features provided by the OS can be generated based upon the observations.

User interaction data can include, but is not limited to, data copied to an OS-provided clipboard by the user, data describing one or more search operations performed by the user utilizing an OS-provided search feature, data describing one or more applications launched by the user by way of the OS, and data describing one or more files opened by the user utilizing the OS. Other types of user interaction data can also be collected and utilized in the manner described herein, some of which is described in greater detail below. Certain types of user interaction data are also pre-processed prior to utilization in some configurations. For example, and without limitation, data copied to an OS-provided clipboard might be schematized prior to utilization.

In one embodiment, the collected user interaction data is provided to a trained machine learning model that is configured to identify a relevant workflow for performing a task based on the collected user interaction data. For example, and without limitation, the user interaction data might indicate that the user has copied data that describes an event (e.g., date, time, location, and details) to an OS-provided clipboard. In response thereto, the trained machine learning model might identify a workflow for quickly and easily creating an event on the user's calendar based upon the data copied to the OS-provided clipboard.

In some embodiments, the trained machine learning model also utilizes metadata associated with user interaction data in training the machine learning model and at runtime to identify relevant workflows. For example, and without limitation, the metadata might define a frequency of occurrence of the interaction of a user with the OS-provided features, an order or sequence of occurrence of the interaction of a user with the OS-provided features, a location of a computing device at a time of the interaction of the user with the OS-provided features, or an identity of one or more other users associated with the interaction of the user with the OS-provided features. Other metadata can also be utilized to train the machine learning model and to identify relevant workflows in other embodiments.

If the trained machine learning model identifies a relevant workflow based on collected user interaction data, a user interface (“UI”) (which might be referred to herein as the “workflow instantiation UI”) may be presented by the computing device that describes the identified workflow and/or confirms that the user would like to execute the workflow. For instance, in the example above, a graphical UI might be presented asking the user if they would like to execute the workflow for automatically creating an event on their calendar based upon the data that they copied to the OS-provided clipboard. Other types of visual and audible user interfaces can be provided in various embodiments. In other embodiments, user action can initiate the execution of a selected workflow without the utilization of a user interface.

The UI can also include an element which, when selected, will cause the computing device to instantiate (i.e., execute) the workflow identified by the trained machine learning model. In the example presented above, for instance, the workflow for creating a new event in a user's calendar might, without any further user interaction, launch a default calendar application, create a new event in the user's calendar, populate the new event with data extracted from the clipboard, and ask the user to confirm that the new event is correct. The workflow might perform other automated operations in other embodiments disclosed herein.

The UI can also include an element through which the user can indicate that the workflow selected by the trained machine learning model is not relevant to their current activity and is, therefore, not to be executed. In this case, the fact that the user deemed the selected workflow not to be relevant to their recent interaction with OS-provided features can be seen as an indication that the trained machine learning model has made a poor prediction. Accordingly, retraining of the trained machine learning model can be triggered in response to the user request to not execute the identified workflow.

As discussed briefly above, in one example the user interaction data includes data copied to an OS-provided clipboard by a user and a workflow that utilizes the data provides functionality for creating a calendar event from the data copied to the OS-provided clipboard. As another example, the user interaction data includes data describing one or more searches for a file performed by a user utilizing an OS-provided search feature and a workflow that utilizes the data provides functionality for adding the file to a recently used files list.

As a further example, the user interaction data can include data (e.g., a hyperlink) copied to an OS-provided clipboard by a user and a workflow that utilizes the data provides functionality for creating a collection (e.g., a list of hyperlinks) containing the data copied to the OS-provided clipboard. As yet another example, the user interaction data might describe the launching of one or more applications by the user by way of the OS and a workflow that utilizes the data provides functionality for automatically launching the one or more applications on behalf of the user at a predetermined time or in response to certain conditions.

As another example, the user interaction data can include a telephone number copied to an OS-provided clipboard by a user and a workflow that utilizes the data provides functionality for placing a call to the telephone number. In another example, the user interaction data includes text in a non-default language copied to an OS-provided clipboard by a user and a workflow that utilizes the data provides functionality for translating the text to a default language. According to another example, the user interaction data includes formatted text copied to an OS-provided clipboard by a user and a workflow that utilizes the data provides functionality for removing the formatting from the text. Other types of user interaction data and other types of workflows for performing relevant tasks will be provided below.

As discussed briefly above, implementations of the technologies disclosed herein can enable more efficient completion of tasks, thereby saving computing resources as compared to when repeated tasks are completed using less efficient methods. Other technical benefits not specifically identified herein can also be realized through implementations of the disclosed technologies.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing architecture diagram that shows a high-level overview of one mechanism disclosed herein for machine learning assisted automation of workflows based on observation of user interaction with OS platform features, according to embodiments disclosed herein;

FIG. 2 is a flow diagram showing a routine that illustrates aspects of one mechanism disclosed herein for training a machine learning model to identify a workflow for performing a task based upon data describing a user's interaction with OS platform features, according to one embodiment disclosed herein;

FIG. 3 is a software architecture diagram showing aspects of one mechanism described herein for pre-processing user interaction data prior to using the user interaction data to train a machine learning model, according to one embodiment disclosed herein.

FIG. 4 is a flow diagram showing a routine that illustrates aspects of the mechanism shown in FIG. 1 for machine learning assisted identification and execution of workflows based on observation of user interaction with OS platform features, according to one embodiment disclosed herein;

FIG. 5A is a user interface diagram showing an illustrative user interface for executing a workflow for creating a new calendar event in response to collecting user interaction data that includes data copied to an OS-provided clipboard that describes an event, according to one embodiment disclosed herein;

FIG. 5B is a user interface diagram showing an illustrative user interface for executing a workflow for creating a new calendar event in response to collecting user interaction data that includes data copied to an OS-provided clipboard that describes an event, according to one embodiment disclosed herein;

FIG. 5C is a user interface diagram showing an illustrative user interface for creating a new calendar event in response to collecting user interaction data that includes data copied to an OS-provided clipboard that describes an event, according to one embodiment disclosed herein;

FIG. 6 is a user interface diagram showing an illustrative user interface for executing a workflow for automatically launching an application in response to collecting user interaction data that describes one or more applications launched by a user by way of an OS, according to one embodiment disclosed herein;

FIG. 7 is a user interface diagram showing an illustrative user interface for executing a workflow for adding a file to a recently used files list in response to collecting user interaction data indicating that a user has repeatedly searched for the file utilizing an OS-provided search feature, according to one embodiment disclosed herein;

FIG. 8 is a user interface diagram showing an illustrative user interface for executing a workflow for adding data (e.g., a hyperlink) to a collection of data in response to collecting user interaction data indicating that a user has previously copied similar data to an OS-provided clipboard, according to one embodiment disclosed herein;

FIG. 9 is a user interface diagram showing an illustrative user interface for executing a workflow for placing a call to a telephone number in response to collecting user interaction data indicating that a user has copied a telephone number to an OS-provided clipboard, according to one embodiment disclosed herein;

FIG. 10 is a user interface diagram showing an illustrative user interface for executing a workflow for translating text from a non-default language to a default language in response to collecting user interaction data indicating that a user has copied text in a non-default language to an OS-provided clipboard, according to one embodiment disclosed herein;

FIG. 11 is a user interface diagram showing an illustrative user interface for executing a workflow for removing formatting from text in response to collecting user interaction data indicating that a user has copied formatted text to an OS-provided clipboard, according to one embodiment disclosed herein;

FIG. 12 is a computer architecture diagram showing an illustrative computer hardware and software architecture for a computing device that can implement aspects of the technologies presented herein; and

FIG. 13 is a network diagram illustrating a distributed computing environment in which aspects of the disclosed technologies can be implemented.

### DETAILED DESCRIPTION

The following detailed description is directed to technologies for machine learning assisted automation of workflows based on observation of user interaction with OS platform features. As discussed briefly above, implementations of the technologies disclosed herein can enable completion of repetitive tasks commonly performed by users using shorter and/or more computationally efficient workflows and simpler operations, which can result in the conservation of computing resources as compared to when workflows are completed manually or using less efficient methods. Additionally, these benefits can be achieved by an OS without requiring applications to be modified in order to provide the disclosed functionality, enabling an OS to provide improved functionality for existing applications. Other technical benefits not specifically mentioned herein can also be realized through implementations of the disclosed subject matter.

While the subject matter described herein is presented in the general context of machine learning assisted automation of workflows based on observation of user interaction with OS platform features, those skilled in the art will recognize that other implementations can be performed in combination with other types of computing systems and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation, etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for machine learning assisted automation of workflows based on observation of user interaction with OS platform features will be described.

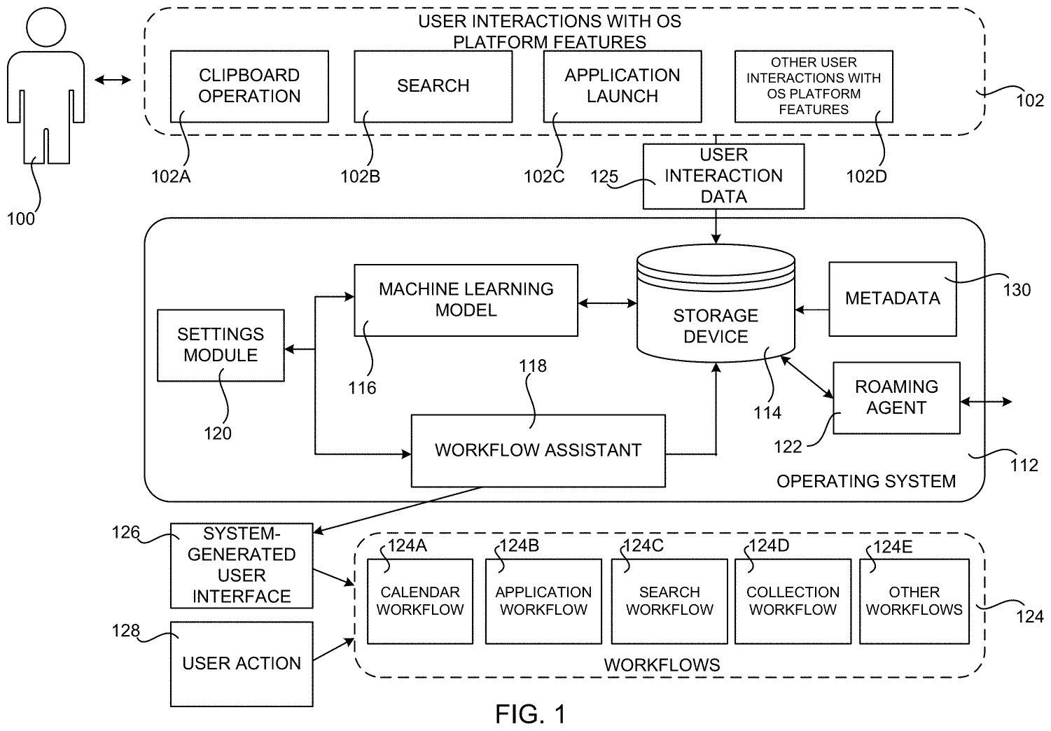

FIG. 1 is a computing architecture diagram that shows a high-level overview of one mechanism disclosed herein for machine learning assisted automation of workflows based on observation of user interaction with OS platform features, according to embodiments disclosed herein. As discussed briefly above, there are many types of workflows that users routinely perform on computing devices to perform desired tasks. In order to complete such tasks, users commonly perform many different user input operations (e.g., mouse cursor movement and selection operations) and initiate multiple context switches between different applications. As a result, completing these types of tasks can be inefficient. Consequently, computing resources such as processor cycles, memory, and network bandwidth might not be utilized efficiently. Moreover, repeated performance of certain tasks can be frustrating for users, particularly if the same tasks have to be performed multiple times per day, which can lead to reduced productivity and inefficient use of computing resources.

In order to address the technical challenges set forth above, and potentially others, technologies are disclosed herein for machine learning assisted automation of workflows based on observation of user interaction with OS platform features. As discussed briefly above, through implementations of the disclosed technologies, a trained machine learning model, such as that shown in FIG. 1 and described below, can be utilized to identify and instantiate relevant workflows for automating user tasks based upon observing user interaction with OS platform features. This can result in the completion of common tasks using shorter and/or more computationally efficient workflows and correspondingly simpler task completion, which can result in the conservation of computing resources such as those described above. Additionally, these benefits can be achieved by an OS alone and without requiring applications to be modified in order to support the disclosed functionality. Other technical benefits not specifically mentioned herein can also be realized through implementations of the disclosed subject matter.

In order to realize the technical benefits mentioned briefly above, and potentially others, the interactions 102 of a user 100, or users, with one or more features (which might be referred to herein as “OS platform features,” “OS-provided features,” or simply “features”) provided by an OS 112 executing on a computing system such as that shown in FIG. 1 can be observed. OS-provided features are functionality provided by the OS 112 itself as opposed to functionality provided by applications executing on a computing device. OS-provided features can include, but are not limited to, functionality for copying/pasting to/from an OS-provided clipboard, search functionality, functionality for launching applications, drag-and-drop UI functionality, functionality for sharing of files or other data, functionality for opening documents or web sites, and/or other types of functionality provided by an OS not expressly identified herein.

As shown in FIG. 1 and described briefly above, a user 100 might engage in interactions 102 with the features provided by the OS 112. For example, and without limitation, the user 100 might engage in an interaction 102A (e.g., a copy or paste operation) with a clipboard provided by the OS 112. The user 100 might similarly engage in an interaction 102B with a search feature provided by the OS 112 such as, for example, to search for applications, documents, or other types of information. As another example, the user 100 might engage in an interaction 102C with an OS-provided feature for launching (i.e., executing) applications on the computing device. A user 100 might perform other types of interactions 102D with other types of features provided by the OS 112 in other embodiments.

As shown in FIG. 1, the OS 112 can observe a user's interactions with OS-provided features and generate user interaction data 125 describing the user's interactions. In this regard, it is to be appreciated that various techniques can be utilized in embodiments to protect a user's privacy with respect to the collected user interaction data 125. For example, and without limitation, users might be asked to opt-in to enable collection of the user interaction data 125, users might be provided the opportunity to opt-out of collection of the user interaction data 125, users might be provided an opportunity to review and approve the collected user interaction data 125, and/or various techniques can be utilized to anonymize the user's identities and/or the collected user interaction data 125 to ensure that no personally identifiable information (“PII”) is collected or disseminated. Other techniques not specifically mentioned herein can also be utilized separately or in combination with those described above to ensure the privacy of users and their data. In some embodiments, a settings module 120 can be provided through which a user 100 can specify preferences regarding the manner in which the collection and utilization of the user interaction data 125 takes place, if at all.

The user interaction data 125 can include, but is not limited to, data copied to an OS-provided clipboard by a user 100, data describing one or more search operations performed by a user 100 utilizing an OS-provided search feature, data describing one or more applications launched by a user 100 by way of the OS 112, and data describing one or more files opened by the user utilizing the OS 100. User interaction data 125 describing other types of user interaction with other OS-provided features can also be collected and utilized in the manner described herein, some of which is described in greater detail below. The user interaction data 125 can be stored in an appropriate storage device 114 on the computing device.

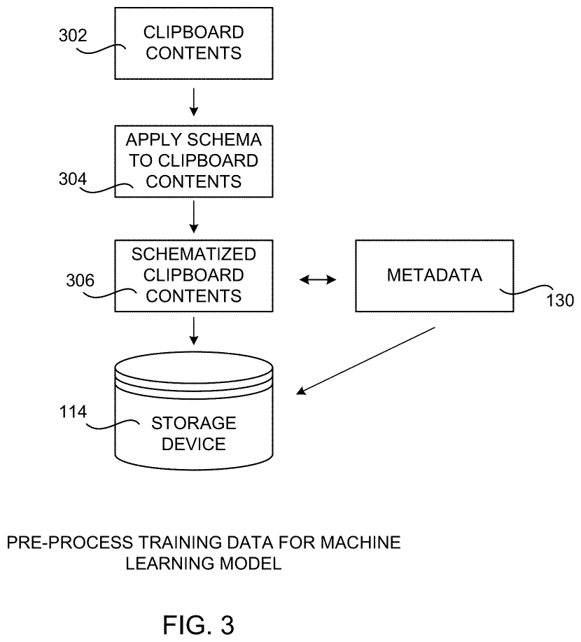

As will be described in greater detail below, certain types of user interaction data 125 might be pre-processed prior to utilization in some configurations. For example, and without limitation, data copied to an OS-provided clipboard might be schematized prior to utilization. Details regarding this process are provided below with regard to FIG. 3.

In some embodiments, metadata 130 associated with the user interaction data 125 is also collected, stored, and utilized. The metadata 130 associated with user interaction data 125 can be used during training of a machine learning model 116 and at runtime to identify relevant workflows. For example, and without limitation, the metadata 130 might define a frequency of occurrence of the interaction of a user 100 with the OS-provided features, an order or sequence of occurrence of the interaction of a user 100 with the OS-provided features, a location of a computing device at a time of the interaction of the user 100 with the OS-provided features, or an identity of one or more other users associated with the interaction of the user 100 with the OS-provided features.

Other types of metadata 130 associated with the user interaction data 125 can also be utilized to train the machine learning model 116 and to identify relevant workflows in other embodiments. For example, and without limitation, metadata 130 obtained from a remote source (e.g., a directory service) can also be utilized together with metadata 130 collected at the user's computing device.

As shown in FIG. 1, a roaming agent 122 can be utilized in some configurations to obtain both user interaction data 125 and associated metadata 130 from one or more other computing devices associated with the same user 100. In this way, a user's interaction with OS-provided features on some or all of their devices can be utilized to train the machine learning model 116 and identify and instantiate relevant workflows in the manner described herein. In some embodiments, the settings module 120 can provide functionality for allowing a user 100 to specify preferences regarding the manner in which user interaction data 125 is collected from their other devices and utilized in the manner described above with regard to FIG. 1.

In this regard, it is to be appreciated that the technologies disclosed herein are not limited to use with a single user 100. For example, and without limitation, in some embodiments, user interaction data 125 might be collected from a group of users 100 and utilized to train the machine learning model 116 in the manner described herein. In this way, workflows utilized by or relevant to multiple users can be identified and suggested to other users.

As shown in FIG. 1, the collected user interaction data 125 and associated metadata 130 is provided to a trained machine learning model 116 that is configured to identify a relevant workflow 124 that defines a sequence of operations for performing a task based on the collected user interaction data 125. For example, and without limitation, the user interaction data 125 might indicate that the user 100 has interacted with OS-platform features to copy data that describes an event (e.g., date, time, location, and details) to an OS-provided clipboard. In response thereto, the trained machine learning model 116 might identify a workflow 124A that defines a sequence of operations for creating an event on the user's calendar based upon the data copied to the OS-provided clipboard.

If the trained machine learning model 116 identifies a relevant workflow 124 based on collected user interaction data 125, a workflow assistant 118 or another component might present a UI 126 (which might be referred to herein as the “workflow instantiation UI 126) that describes the identified workflow 124 and asks the user 100 if they would like to execute the identified workflow 124. For instance, in the example described above, a graphical UI 126 might be presented asking the user 100 if they would like to execute the workflow 124A for automatically creating an event on their calendar based upon the data that they copied to the OS-provided clipboard. Other types of visual and audible user interfaces can be provided in various embodiments.

In other embodiments, user action 128 can initiate the execution of a selected workflow 124 without the utilization of a separate, system-generated UI 126. For example, and without limitation, in the example above, a user 100 might copy information about an event to an OS-provided clipboard. Following this operation, the user 100 might select a pre-defined combination of keys in order to initiate execution of the workflow 124A for creating a new calendar entry that is pre-populated with the information about the event that was copied to the OS-provided clipboard. Other types of operations can be performed by a user to execute an identified workflow 124 without utilizing a UI 126 in other embodiments.

As will be discussed in greater detail below, the UI 126 can include an element which, when selected by the user 100, will cause the computing device to instantiate (i.e., execute) the workflow 124 identified by the trained machine learning model 116 to perform a desired task. In the example presented above, for instance, the workflow 124A for creating a new event in a user's calendar might, without any further user interaction, perform operations to launch a default calendar application on the computing device, create a new event in the user's calendar, populate the new event with data extracted from the clipboard, and ask the user 100 to confirm that the new event is correct. The workflow 124A might perform other automated operations in other embodiments disclosed herein.

The UI 126 can also include an element through which a user 100 can indicate that the workflow 124 selected by the trained machine learning model 116 is not to be executed. In this case, the fact that the user 100 deemed the selected workflow 124 not to be relevant to their recent interactions 102 with OS-provided features can be seen as an indication that the trained machine learning model 116 has made a poor prediction. Accordingly, retraining of the trained machine learning model 116 can be triggered in response to the user request to not execute the identified workflow 124.

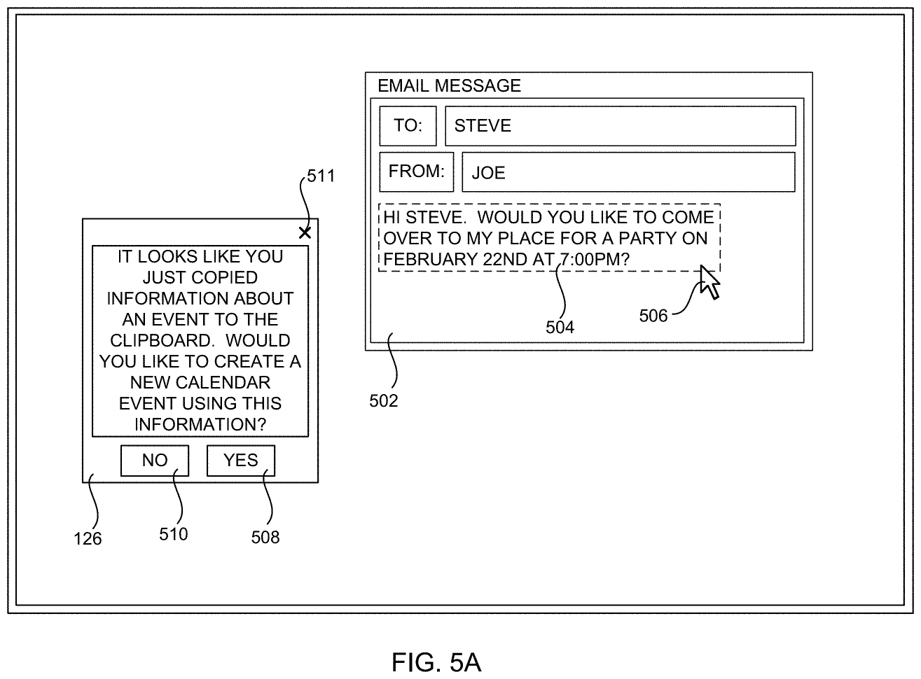

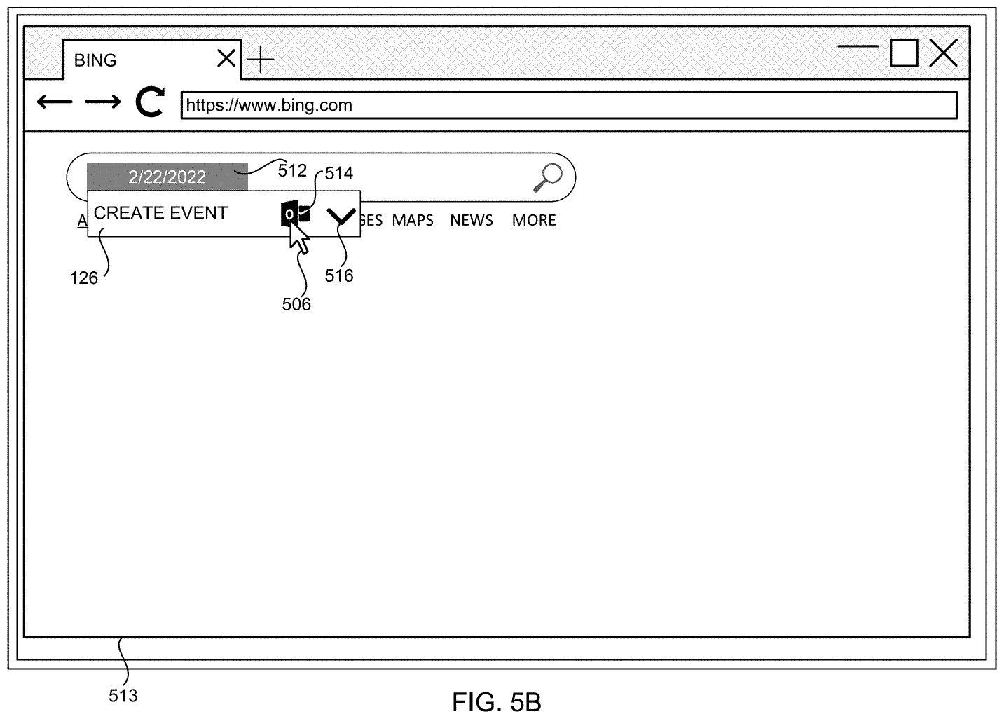

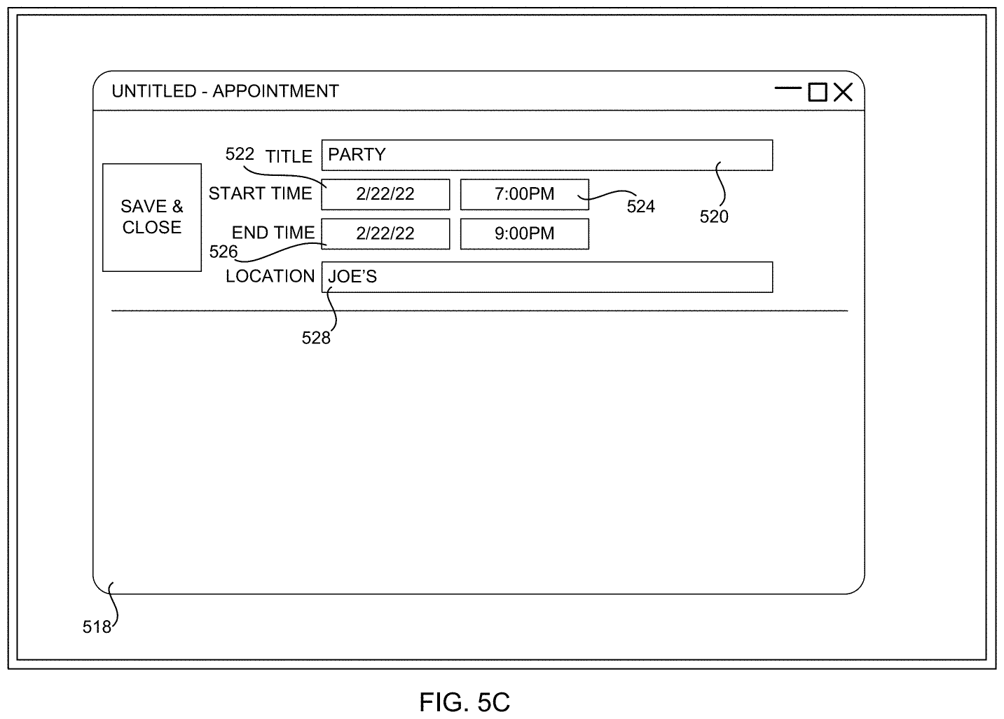

As discussed briefly above, in one example the user interaction data 125 includes data copied to an OS-provided clipboard by a user 100 and a workflow 124A that utilizes the data provides functionality for creating a calendar event from the data copied to the OS-provided clipboard. Additional details regarding this particular example will be provided below with regard to FIGS. 5A-5C.

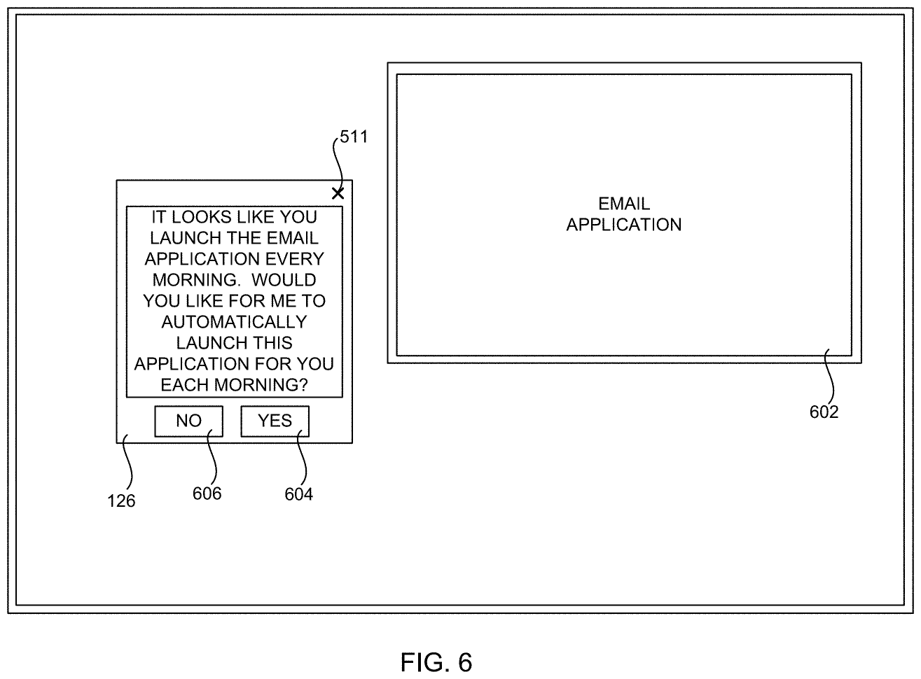

As yet another example, the user interaction data 125 might describe the launching of one or more applications by the user 100 by way of the OS and a workflow 124B that utilizes the data provides functionality for automatically launching the one or more applications on behalf of the user 100 at a predetermined time or in response to certain conditions. Additional details regarding this particular example will be provided below with regard to FIG. 6.

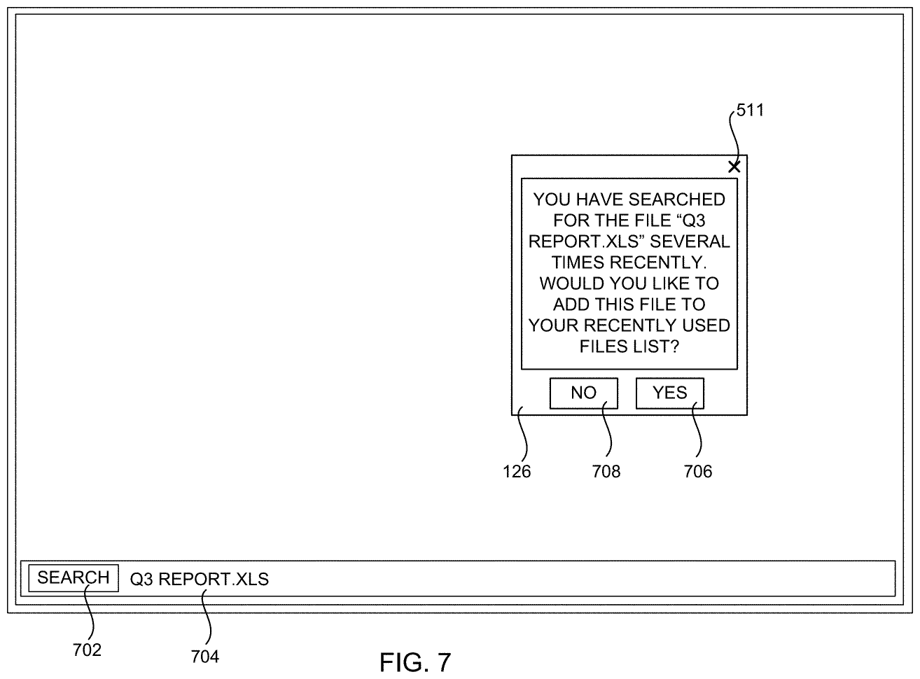

As another example, the user interaction data 125 includes data describing one or more searches for a file performed by a user 100 utilizing an OS-provided search feature and a workflow 124C that utilizes the data provides functionality for adding the file to a recently used files list. Additional details regarding this particular example will be provided below with regard to FIG. 7.

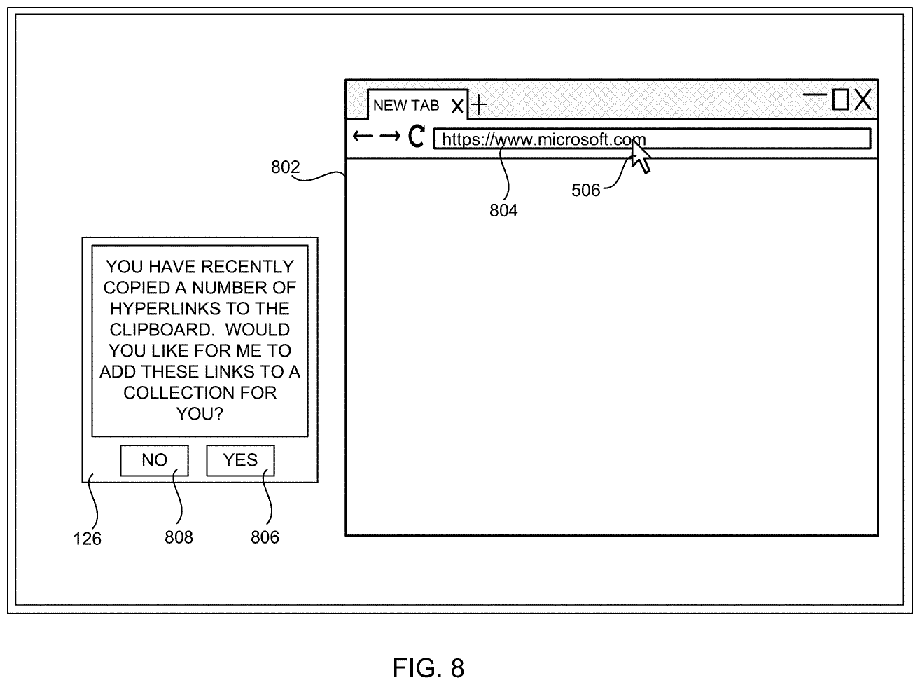

As a further example, the user interaction data 125 can include data (e.g., a hyperlink) copied to an OS-provided clipboard by a user 100 and a workflow 124D that utilizes the data provides functionality for creating a collection (e.g., a list of hyperlinks) containing the data copied to the OS-provided clipboard. Additional details regarding this particular example will be provided below with regard to FIG. 8.

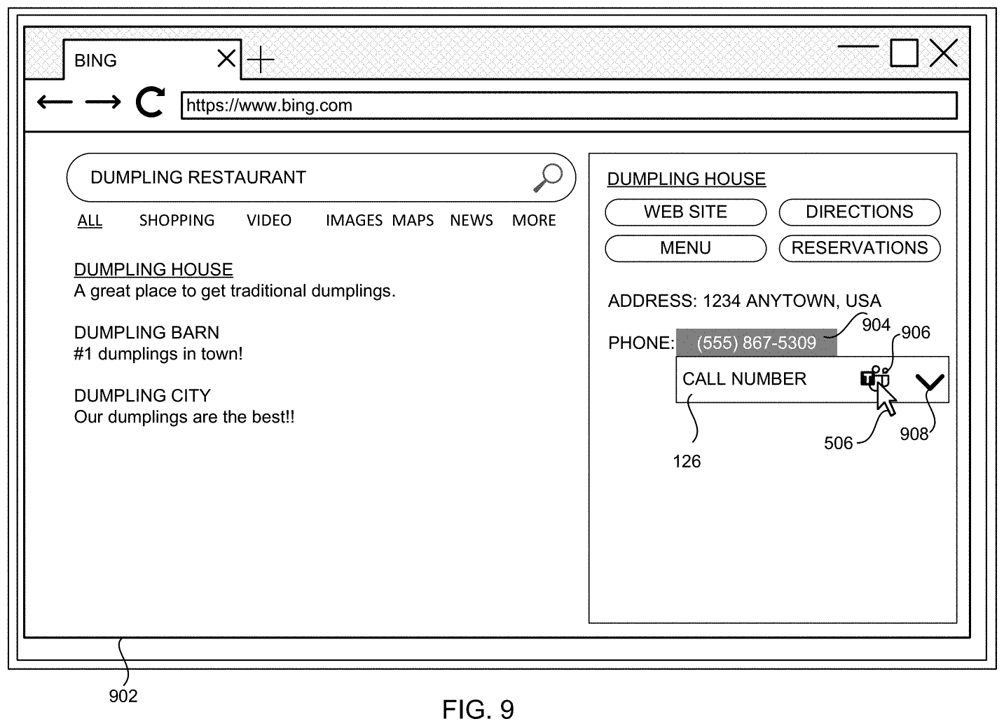

As another example, the user interaction data 125 can include a telephone number copied to an OS-provided clipboard by a user 100 and a workflow 124E that utilizes the data provides functionality for placing a call to the telephone number. Details regarding this particular example will be provided below with regard to FIG. 9.

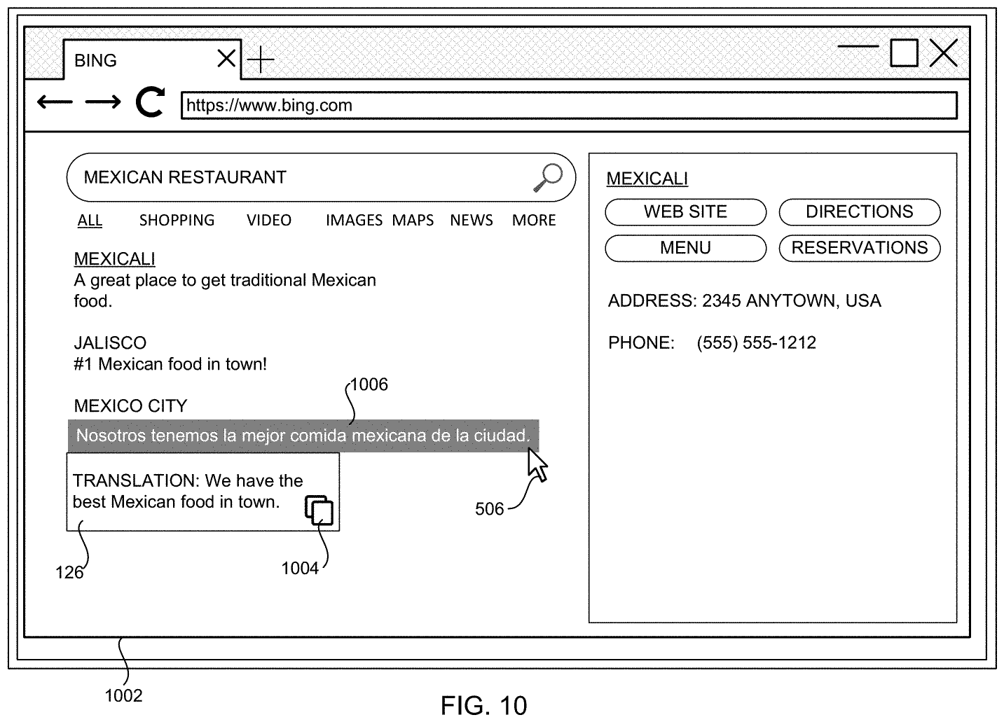

In another example, the user interaction data 125 includes text in a non-default language copied to an OS-provided clipboard by a user 100 and a workflow 124E that utilizes the data provides functionality for translating the text to a default language. Details regarding this particular example will be provided below with regard to FIG. 10.

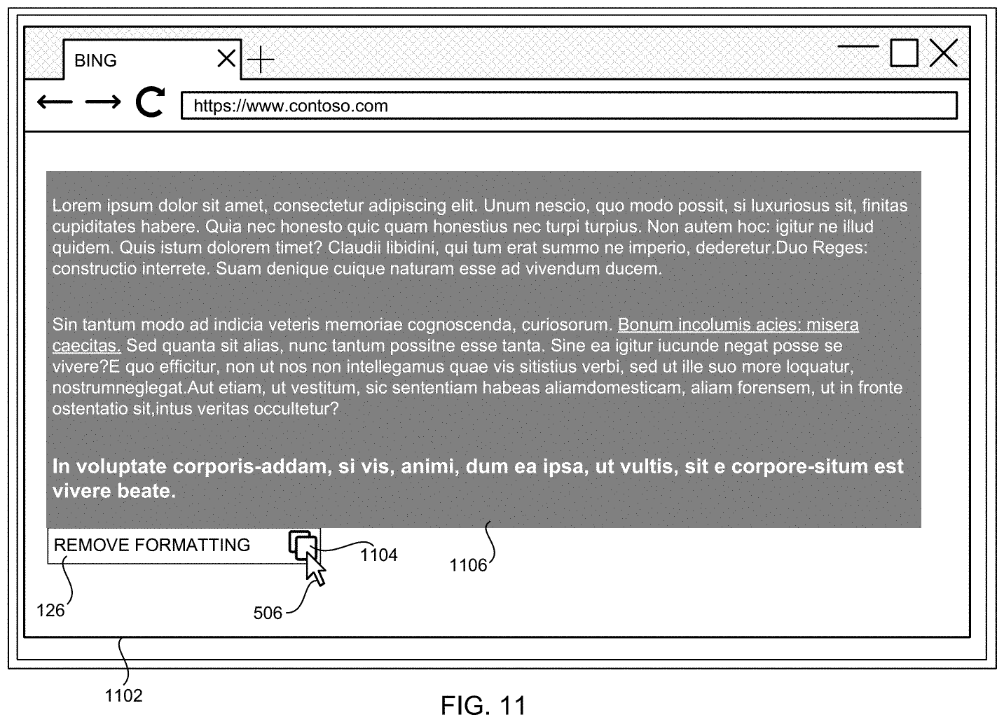

According to another example, the user interaction data 125 includes formatted text copied to an OS-provided clipboard by a user 100 and a workflow 124E that utilizes the data provides functionality for removing the formatting from the text. Details regarding this particular example will be provided below with regard to FIG. 11. Other types of user interaction data 125 and other types of workflows 124E for automating relevant tasks may be utilized in other embodiments.

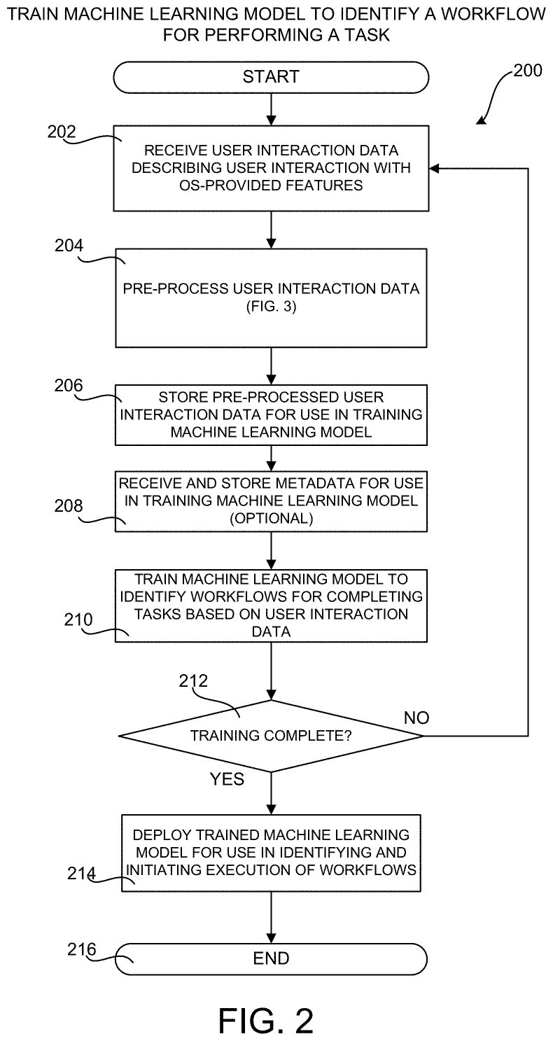

FIG. 2 is a flow diagram showing a routine 200 that illustrates aspects of one mechanism disclosed herein for training a machine learning model 116 to identify a workflow 124 for performing a task based upon user interaction data 125 describing a user's interaction with OS platform features, according to one embodiment disclosed herein. It should be appreciated that the logical operations described herein with regard to FIG. 2, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The routine 200 begins at operation 202, where an OS 112 observes user interactions 124 with a computing device during the user's normal use of the computing device, and user interaction data 125 is generated that describes the user's interactions 124 with the computing device. As discussed above, the user interaction data 125 defines the interactions 124 of the user 100 with features provided by an OS 112 executing on the computing device. As also discussed above, various techniques can be utilized in order to ensure the privacy of users and their data. From operation 202, the routine 200 proceeds to operation 204, where, as discussed briefly above, the collected user interaction data 125 might be pre-processed prior to utilization in the manner described herein.

Turning momentarily to FIG. 3, a software architecture diagram showing aspects of one mechanism described herein for pre-processing user interaction data 125 will be described. As shown in FIG. 3, there are certain types of user interaction data 125 that might be pre-processed in order to make optimal and/or preferred use of the user interaction data 125 during training of the machine learning model 116 and runtime. In the example shown in FIG. 3, this user interaction data 125 includes the contents 302 of an OS-provided clipboard. As discussed above, for instance, a user 100 might copy data regarding an event to the OS-provided clipboard in some embodiments.

In order to utilize this data most effectively, the contents 302 of the clipboard are schematized at operation 304. For instance, the various data types (e.g., date, time, location) in the contents 302 of the clipboard might be identified and a schema might be applied to the data to create schematized clipboard contents 306. Various schemas can be applied to the data and formalized utilizing extensible markup language (“XML”), JavaScript Object Notation (“JSON”), or another type of markup language to define the schema.

As also shown in FIG. 3, all or portions of the metadata 130 described above might also be added to the schema for the user interaction data 125. For instance, in the example described above, the time that the data was copied to the OS-provided clipboard might be added to the schematized clipboard contents 306. The schematized clipboard contents 306 and/or the metadata 130 associated with the user interaction data 125 can then be copied to the storage device 114 for use in the manner described herein. It is to be appreciated that the pre-processing illustrated in FIG. 3 and described above is merely illustrative and that other types of pre-processing alternative or in addition to schematizing clipboard data might be performed in other embodiments.

Returning now to FIG. 2, additional details regarding the routine 200 for training the machine learning model 116 to identify workflows 124 will be provided. In particular, the routine 200 proceeds from operation 204 to operation 206, where the pre-processed user interaction data 125 is stored in the storage device 114 for use in training the machine learning model 116. From operation 206, the routine 200 proceeds to operation 208 where, as described briefly above, metadata 130 associated with the user interaction data 125 might also be obtained and stored in the storage device 114.

From operation 208, the routine 200 proceeds to operation 210, where the machine learning model 116 is trained to identify, based at least in part on the user interaction data 125, a workflow 124 for performing a task. Training of the machine learning model 116 can include various types of machine learning including, but not limited to, supervised or unsupervised machine learning, reinforcement learning, self-learning, feature learning, sparse dictionary learning, anomaly detection, or association rules. Accordingly, the trained machine learning model 116 can be implemented as one or more of artificial neural networks, decision trees, support vector machines, regression analysis, Bayesian networks, or genetic algorithms. Other machine learning techniques known to those skilled in the art can also be utilized in other embodiments.

From operation 210, the routine 200 proceeds to operation 212, where a determination is made as to whether training of the machine learning model 116 has completed. If training has not yet completed, the routine 200 proceeds from operation 212 back to operation 202, where additional user interaction data 125 can be collected and additional training can occur in the manner described above.

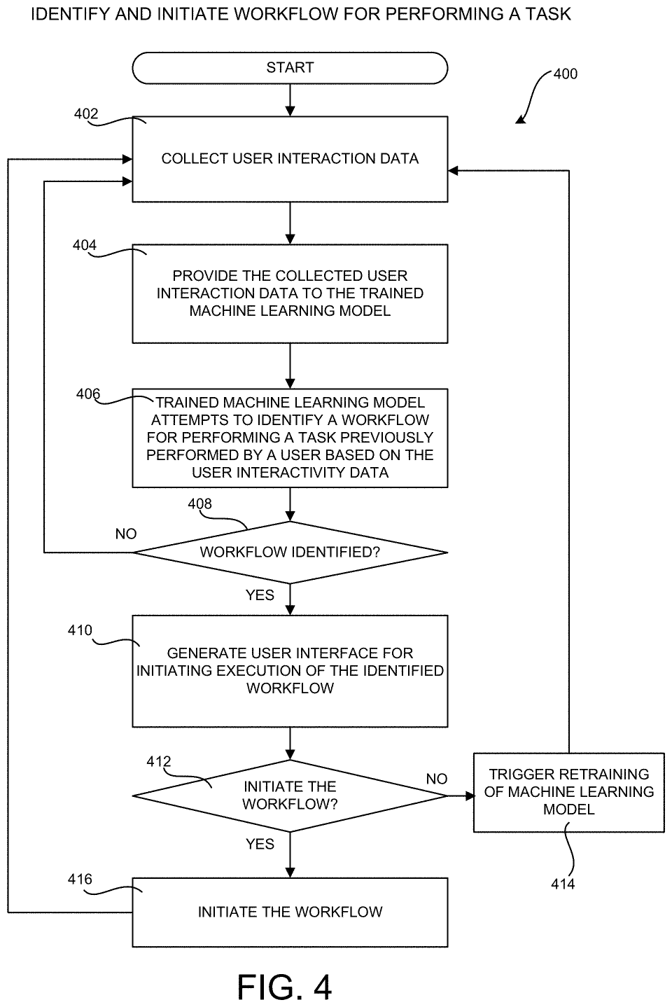

If, at operation 212, it is determined that training has completed, the routine 200 proceeds from operation 212 to operation 214. At operation 214, the trained machine learning module 116 can be deployed for runtime identification and instantiation of workflows 124 in the manner described herein. In this regard, it is to be appreciated that training in the manner shown in FIG. 2 can be performed repeatedly and/or periodically in order to ensure that the trained machine learning model 116 can accurately identify workflows 124 relevant to a user's current interaction with OS-provided features. Additional details regarding this process will be provided below with regard to FIG. 4

As mentioned briefly above, interaction by a user 100 with the UI 126 can be utilized to continually update the trained machine learning model 116 to improve its ability to accurately identify relevant workflows 124 for completing user tasks. For instance, and as described in greater detail herein, the UI 126 can include an element through which the user 100 can indicate that a workflow 124 selected by the trained machine learning model 116 is not relevant to their current activity. In this case, the fact that the user 100 indicated that the workflow was not relevant to their current activity can be seen as an indication that the trained machine learning model 116 has made a poor prediction. Accordingly, retraining of the trained machine learning model 116 in the manner shown in FIG. 2 can be triggered in response to the user's request to not instantiate the recommended workflow 124.

FIG. 4 is a flow diagram showing a routine 400 that illustrates additional aspects of the mechanism shown in FIG. 1 for machine learning assisted identification and execution of workflows 124 based on observation of user interaction with OS platform features, according to one embodiment disclosed herein. The routine 400 begins at operation 402, where user interaction data 125 is collected in the manner described above during a user's normal use of the OS of a computing device such as that shown in FIG. 1.

From operation 402, the routine 400 proceeds to operation 404, where the collected user interaction data 125 is provided to the trained machine learning model 116. The collected user interaction data 125 might be pre-processed in the manner described above with regard to FIG. 3 or in another manner prior to being provided to the trained machine learning model 116. Additionally, metadata 130 associated with the user interaction data 125 might also be collected and provided to the trained machine learning model 116.

From operation 404, the routine 400 proceeds to operation 406, where the trained machine learning model 116 attempts to generate a prediction of a workflow 124 that is relevant to the current activity (i.e., the user's recent interaction(s) with OS platform features) of the user 112 based upon the collected user interaction data 125. From operation 406, the routine 400 proceeds to operation 408, where a determination is made as to whether the trained machine learning model 116 was able to predict a workflow 124 relevant to the user's current activity. If not, the routine 400 proceeds back to operation 402, where the trained machine learning model 116 can continue to process user interaction data 125 and attempt to identify relevant workflows 124 for automating user tasks.

If the trained machine learning model 116 is able to identify a workflow 124 based on the user's current interaction with OS platform features, the routine 400 proceeds from operation 408 to operation 410, where a UI 126 is presented to the user 100 that identifies the workflow 124 selected by the trained machine learning model 116.

As discussed above, and in further detail below, the UI 126 can include an element which, when selected, will instantiate the selected workflow 124 and an element which, when selected, will cause the selected workflow 124 not to be instantiated. If the user 100 selects the element for instantiating the selected workflow 124, the routine 400 proceeds to operation 416, where the selected workflow 124 is instantiated (i.e., executed) to perform operations for completing the associated task. The routine 400 then returns back to operation 402, where the process described above may be repeated in order to select and execute other workflows 124.

If the user 112 selects the element requesting that the selected workflow 124 not be instantiated, the routine 400 proceeds from operation 412 to operation 414, where retraining of the machine learning model 116 might be performed in the manner described above. The routine 400 then proceeds from operation 414 to operation 402, where the process described above may be repeated.

FIG. 5A is a user interface diagram showing aspects of an illustrative user interface 126 for executing a workflow 124A for creating a new calendar event in response to collecting user interaction data 125 that includes data copied to an OS-provided clipboard that describes an event, according to one embodiment disclosed herein. In the illustrated example, a user 100 has created an email message 502 and selected text 504 in the email message 502 using a mouse cursor 506. The user 100 has also copied the text 504 to the OS-provided clipboard using an appropriate key sequence or menu selection. In this regard, it is to be appreciated that while the user 100 has copied an entire sentence to the OS-provided clipboard in the illustrated example, a user might 100 copy more or less text to the clipboard in other embodiments.

In response to the text 504 being copied to the OS-provided clipboard by the user 100, user interaction data 125 including the text 504 is provided to the trained machine learning model 116. As discussed above, the text 504 might be pre-processed, for example to schematize the data contained therein prior to providing the user interaction data 125 to the trained machine learning model 116.

In response to receiving the user interaction data 125 including the text 504, the trained machine learning model 116 has identified a workflow 124A relevant to the user's interaction with the OS-provided feature, in this case the clipboard. Consequently, the workflow assistant 118 has caused a UI 126 to be presented that identifies the selected workflow 124A. The UI 126 includes a description of the workflow 124A that indicates that the workflow 124A can automate the process of creating a new calendar event from the contents of the clipboard (i.e., a new event for “Feb. 22, 2022 at 7:00 p.m.”).

As discussed above, the UI 126 also includes an element 508 which, when selected, will cause the identified workflow 124A to be executed to perform the associated task. The UI 126 also includes an element 510 which, when selected, will cause the identified workflow 124A not to be performed. Selection of the UI control 511 can also close the UI 126 in a more conventional manner and would also be seen as an indication that the identified workflow 124A is not to be performed. Selection of the element 510 or the UI control 511 might also initiate retraining of the machine learning model 116.

FIG. 5B is a user interface diagram showing an illustrative user interface 126 for executing a workflow 124A for creating a new calendar event in response to collecting user interaction data 125 that includes data copied to an OS-provided clipboard that describes an event, according to one embodiment disclosed herein. In the example illustrated in FIG. 5B, a user 100 has selected text 512 using a mouse cursor 506 in a UI window 513 presented by a web browser application. The user 100 has also copied the text 512 to the OS-provided clipboard using an appropriate key sequence or menu selection.

In response to the text 512 being copied to the OS-provided clipboard by the user 100, user interaction data 125 including the text 512 is provided to the trained machine learning model 116. As discussed above, the text 512 might be pre-processed, for example to schematize the data contained therein prior to providing the user interaction data 125 to the trained machine learning model 116.

In response to receiving the user interaction data 125 including the text 512, the trained machine learning model 116 has identified a workflow 124A relevant to the user's interaction with the OS-provided feature, in this case the clipboard. Consequently, the workflow assistant 118 has caused a UI 126 to be presented that identifies the selected workflow 124A. As in the example shown in FIG. 5A, the UI 126 shown in FIG. 5B includes a description of the workflow 124A that indicates that the workflow 124A can automate the process of creating a new calendar event from the contents of the clipboard (i.e., a new event for “Feb. 22, 2022”).

The example UI 126 shown in FIG. 5B also includes an icon 514 or other type of UI element corresponding to an application (in this case a personal information manager (“PIM”) application that provides calendaring functionality) that can implement all or a portion of the steps of the selected workflow 124A. The UI element 516 is presented in some embodiments which, when selected, will present icons or other types of UI elements corresponding to other applications that can be utilized to implement all or a portion of the steps of the selected workflow 124A.

In this regard, it is to be appreciated that, in some embodiments, applications can register with the operating system 122 as being capable of implementing workflows 124 associated with certain types of user interaction data 125. In these embodiments, an icon 514 or other type of UI element can be presented in the UI 126 corresponding to applications that are capable of implementing workflows 124 relevant to the user interaction data 125.

It is to be further appreciated that the user interaction data 125 can be generated by any application. For example, and without limitation, text 512 can be copied to the OS-provided clipboard by a user 100 while using any application executing on the operating system 122. In this way, aspects of the functionality disclosed herein can be provided in an application-agnostic manner.

FIG. 5C is a user interface diagram showing an illustrative user interface 518 for creating a new calendar event in response to collecting user interaction data 125 that includes data copied to an OS-provided clipboard that describes an event, according to one embodiment disclosed herein. If the user requests execution of the selected workflow 124A in the examples of FIGS. 5A and 5B, the workflow 124A may be instantiated. For example, and without limitation, an application program capable of executing all or a portion of the steps of the workflow might be executed. In this example, a PIM application has been executed that provides calendaring functionality.

Additionally, the workflow 124A has caused the PIM application to create a new calendar event based upon the user interaction data 125. In response thereto, the PIM application has displayed the window 518, which provides functionality for creating a new event on a calendar. The workflow 124A has also populated the new calendar event with information extracted from the user interaction data 125. For example, and without limitation, the fields 520, 522, 524, 526, and 528 have been populated with a title of the event, the start and end times of the event, and the location of the event, respectively, from the user interaction data 125 obtained in the example of FIG. 5A. The user 100 can then edit the pre-populated data and, when complete, can save the newly created calendar event.

FIG. 6 is a user interface diagram showing aspects of an illustrative user interface 126 for executing a workflow 124B for automatically launching an application in response to collecting user interaction data 125 that describes one or more applications launched by a user by way of an OS, according to one embodiment disclosed herein. In the illustrated example, a user 100 has launched an email application 602. Additionally, in this example, the user 100 launches the email application 602 around the same time every day.

In response to the launching of the email application 602, user interaction data 125 including data identifying the email application 602 and the time at which it was launched is provided to the trained machine learning model 116. In response to receiving the user interaction data 125 identifying the application 602 and the time at which it was launched, the trained machine learning model 116 has identified a workflow 124B relevant to the user's interaction with the OS-provided feature. In this case, the trained machine learning model 116 has identified a pattern of launching the email application 602 at around the same time every day. Accordingly, the trained machine learning model 116 has selected a workflow 124B for launching applications on a schedule.

In response to identifying the workflow 124B, the workflow assistant 118 has caused a UI 126 to be presented that identifies the selected workflow 124B. The UI 126 includes a description of the workflow 124B that indicates that the workflow 124A can automate the process of launching the email application 602 every morning for the user 100. Multiple applications can be launched automatically in a similar fashion.

As discussed above, the UI 126 also includes an element 604 which, when selected, will cause the identified workflow 124B to be executed to perform a desired task (i.e., launching the email application 602 each morning). The UI 126 also includes an element 606 which, when selected, will cause the identified workflow 124B not to be performed. Selection of the UI control 511 can also close the UI 126 in a more conventional manner and would also be seen as an indication that the identified workflow 124B is not to be performed. As discussed above, selection of the element 606 or the UI control 511 might also initiate retraining of the machine learning model 116.

In a similar example to that presented with reference to FIG. 6, the trained machine learning model 116 might determine that a user 100 opens the same document, set of documents, or hyperlinks on a regular schedule. For instance, a user 100 might open a collection of documents, applications, hyperlinks, or other objects in preparation for a regularly scheduled meeting. In this example, the trained machine learning model 116 might suggest to the user 100 a workflow 124 for automating the process of opening the documents, applications, hyperlinks, or other objects according to the identified schedule.

In some embodiments, the UI 126 that is presented in the embodiment illustrated with respect to FIG. 6 can provide other UI elements for specifying additional aspects of the manner in which the workflow 124 for opening documents or other objects is to be performed. For example, and without limitation, such a UI 126 might include UI controls through which a user can specify the time or times of day at which a document, application, or other object is opened or launched, the amount of time prior to a meeting or other event that a document, application, or other object is opened or launched, add additional documents, applications, or objects to the workflow, or UI elements for specifying other aspects of the manner in which the workflow 124 for opening documents or other objects is to be performed.

FIG. 7 is a user interface diagram showing aspects of an illustrative user interface 126 for executing a workflow 124C for adding a file to a list of favorite documents, placing a link to the file on the OS desktop, or otherwise making the file more accessible to the user in response to collecting user interaction data 125 indicating that a user has repeatedly searched for the file utilizing an OS-provided search feature, according to one embodiment disclosed herein. In the illustrated example, a user 100 has utilized an OS-provided search feature 702 to search for a file 704 (“Q3 Report.XLS”). In this example, the user 100 has also recently performed a search for the same file.

In response to the search operation being performed using the OS-provided search feature 702, user interaction data 125 including the identity of the file is provided to the trained machine learning model 116. In response to receiving the user interaction data 125 including the name of the file 704, the trained machine learning model 116 has identified a workflow 124C relevant to the user's interaction with the OS-provided feature, in this case a workflow 124C for adding a frequently searched file 704 to a list of favorite documents (another OS-provided feature). Consequently, the workflow assistant 118 has caused a UI 126 to be presented that identifies the selected workflow 124C. The UI 126 includes a description of the workflow 124C that indicates that the workflow 124A can automate the process of adding the file 704 to the list of favorite documents.

As discussed above, the UI 126 also includes an element 706 which, when selected, will cause the identified workflow 124C to be executed to perform a desired task (i.e., adding the file 704 to the OS-provided list of favorite documents). The UI 126 also includes an element 708 which, when selected, will cause the identified workflow 124C not to be performed. Selection of the UI control 511 can also close the UI 126 in a more conventional manner and would also be seen as an indication that the identified workflow 124C is not to be performed. As discussed above, selection of the element 708 or the UI control 511 might also initiate retraining of the machine learning model 116.

In an example similar to that presented with reference to FIG. 7, a user 100 might search for an application every day or on another schedule using the OS-provided search feature 702. When the application has been located, the user 100 might select the application to launch it. In this example, the trained machine learning model 116 might recognize this pattern and suggest a workflow 124 to the user for pinning an icon associated with the application to a taskbar or another location for quick access. In this manner, the user 100 can be freed of the daily task of searching for the desired application.

FIG. 8 is a user interface diagram showing aspects of an illustrative user interface 126 for executing a workflow 124D for adding a hyperlink to a collection in response to collecting user interaction data 125 indicating that a user 100 has previously copied hyperlinks to an OS-provided clipboard, according to one embodiment disclosed herein. In the illustrated example, a user 100 has launched a web browser application that has displayed the window 802, selected a hyperlink 804 using a mouse cursor 506, and copied the hyperlink 804 to the OS-provided clipboard.

In response to the user 100 copying the hyperlink 804 to the OS-provided clipboard, user interaction data 125 including the hyperlink 804 is provided to the trained machine learning model 116. In response to receiving the user interaction data 125 including hyperlink 804, the trained machine learning model 116 has identified a workflow 124D relevant to the user's interaction with the OS-provided feature, in this case the clipboard.

In particular, the trained machine learning model 116 has identified a pattern indicating that the user 100 has recently copied other hyperlinks to the clipboard. Consequently, the workflow assistant 118 has caused a UI 126 to be presented that identifies the selected workflow 124D. The UI 126 includes a description of the workflow 124D that indicates that the workflow 124D can automate the process of creating a collection that includes the hyperlink 804. The collection might be provided by a browser application, a note-taking application, a word processing application, an email application, or another application suitable for creating a collecting of information such as hyperlinks. In this regard, it is to be appreciated that collections containing data types other than hyperlinks can be created in a similar fashion.

As discussed above, the UI 126 also includes an element 806 which, when selected, will cause the identified workflow 124D to be executed to perform the a desired task. The UI 126 also includes an element 808 which, when selected, will cause the identified workflow 124D for creating a collection not to be performed. Selection of the UI control 512 can also close the UI 126 in a more conventional manner and would also be seen as an indication that the identified workflow 124D is not to be performed. As indicated previously, selection of the element 808 or the UI control 512 might also initiate retraining of the machine learning model 116.

In some embodiments, the UI 126 that is presented in the embodiment illustrated with respect to FIG. 8 can provide other UI elements for specifying additional aspects of the manner in which the workflow 124D for creating a collection is to be performed. For example, and without limitation, such a UI 126 might include a UI control through which a user can specify the application that is to be used to create the collection, a UI control showing the hyperlinks that are to be added to the collection and that allows the user to add hyperlinks to or delete hyperlinks from the new collection, or other UI elements for specifying other aspects of the manner in which the workflow 124 for creating a collection is to be performed.

FIG. 9 is a user interface diagram showing an illustrative user interface 126 for executing a workflow 124E for placing a call to a telephone number in response to collecting user interaction data 125 indicating that a user 100 has copied a telephone number to an OS-provided clipboard, according to one embodiment disclosed herein. In the example illustrated in FIG. 9, a user 100 has selected text 902 using a mouse cursor 506 in a UI window 902 presented by a web browser application. The user 100 has also copied the text 904 to the OS-provided clipboard using an appropriate key sequence or menu selection.

In response to the text 904 being copied to the OS-provided clipboard by the user 100, user interaction data 125 including the text 904 is provided to the trained machine learning model 116. As discussed above, the text 904 might be pre-processed, for example to schematize the data contained therein prior to providing the user interaction data 125 to the trained machine learning model 116.

In response to receiving the user interaction data 125 including the text 904, the trained machine learning model 116 has identified a workflow 124E relevant to the user's interaction with the OS-provided feature, in this case the clipboard. Consequently, the workflow assistant 118 has caused a UI 126 to be presented that identifies the selected workflow 124E, in this case a workflow for completing a telephone call to a telephone number identified in the text 904. As in the example shown in FIGS. 5A and 5B, the UI 126 shown in FIG. 9 includes a description of the workflow 124E that indicates that the workflow 124E can automate the process of calling the identified telephone number.

The example UI 126 shown in FIG. 9 also includes an icon 506 or other type of UI element corresponding to an application (in this case a communications application that provides functionality for placing and receiving phone calls) that can implement all or a portion of the steps of the selected workflow 124E. The UI element 908 is presented in some embodiments which, when selected, will present icons or other types of UI elements corresponding to other applications that can be utilized to implement all or a portion of the steps of the selected workflow 124E. In this regard it is to be appreciated that the embodiment illustrated in FIG. 9 is not limited to calling telephone numbers and that other types of communications can be initiated to other types of communication endpoints in a similar manner.

FIG. 10 is a user interface diagram showing an illustrative user interface 126 for executing a workflow 124E for translating text from a non-default language to a default language in response to collecting user interaction data 125 indicating that a user 100 has copied text in a non-default language to an OS-provided clipboard, according to one embodiment disclosed herein. In the example illustrated in FIG. 10, a user 100 has selected text 1006 using a mouse cursor 506 in a UI window 1002 presented by a web browser application. The user 100 has also copied the text 1006 to the OS-provided clipboard using an appropriate key sequence or menu selection. In the example shown in FIG. 10, the text 1006 copied to the OS-provided clipboard is in a language (i.e., Spanish) that is different than the default language (e.g., English) of the computing device upon which the web browser application is executing.

In response to the text 1006 in the non-default language being copied to the OS-provided clipboard by the user 100, user interaction data 125 including the text 1006 is provided to the trained machine learning model 116. As discussed above, the text 1006 might be pre-processed, for example to schematize the data contained therein prior to providing the user interaction data 125 to the trained machine learning model 116.

In response to receiving the user interaction data 125 including the text 1006, the trained machine learning model 116 has identified a workflow 124E relevant to the user's interaction with the OS-provided feature, in this case the clipboard. Consequently, the workflow assistant 118 has caused a UI 126 to be presented that identifies the selected workflow 124E, in this case a workflow for translating the text 1006 to the default language.

In the example shown in FIG. 10, the text 1006 is automatically translated to the default language and presented in the UI 126 in response to the text 1006 being copied to the OS-provided clipboard. A UI element 1004 is also presented in the UI 126 which, when selected, will cause the translated text to be copied to the OS-provided clipboard. In other embodiments, the UI 126 may include a description of the workflow 124E that indicates that the workflow 124E can automate the process of translating the text 1006 copied to the OS-provided clipboard and UI elements for initiating the selected workflow 124E.

FIG. 11 is a user interface diagram showing an illustrative user interface 126 for executing a workflow 124E for removing formatting from text in response to collecting user interaction data 125 indicating that a user 100 has copied formatted text to an OS-provided clipboard, according to one embodiment disclosed herein. In the example illustrated in FIG. 11, a user 100 has selected text 1106 using a mouse cursor 506 in a UI window 1102 presented by a web browser application. The user 100 has also copied the text 1106 to the OS-provided clipboard using an appropriate key sequence or menu selection. In the example shown in FIG. 11, the text 1106 copied to the OS-provided clipboard is formatted text that includes formatting, such as hyperlinks, tables, bulleted or numbered lists, qualitative formatting (e.g., font family), quantitative formatting (e.g., font size and color), style of emphasis formatting (e.g., boldface or italics), or style of notation formatting (e.g., strikethrough or superscript).

In response to the formatted text 1106 being copied to the OS-provided clipboard by the user 100, user interaction data 125 including the text 1106 is provided to the trained machine learning model 116. As discussed above, the text 1106 might be pre-processed, for example to schematize the data contained therein prior to providing the user interaction data 125 to the trained machine learning model 116.

In response to receiving the user interaction data 125 including the text 1106, the trained machine learning model 116 has identified a workflow 124E relevant to the user's interaction with the OS-provided feature, in this case the clipboard. Consequently, the workflow assistant 118 has caused a UI 126 to be presented that identifies the selected workflow 124E, in this case a workflow for removing the formatting from the formatted text 1106. In the example shown in FIG. 11, a UI element 1104 is presented in the UI 126 which, when selected such as by using the mouse cursor 506, will cause the formatting to be removed from the text 1106 and the unformatted text to be copied to the OS-provided clipboard.

It is to be appreciated that the UI 126 shown in FIGS. 5A-11 and described above is merely illustrative and that other types of UIs might be utilized in other embodiments to trigger the execution of a workflow or to indicate that a workflow is not to be performed. In this regard, it is to be appreciated that while the UI 126 is illustrated as a modal dialog box in some embodiments, non-modal UIs can also be utilized. For instance, a UI might be provided that does not require a user to react immediately or prevent the user from interacting with other on-screen UI elements. The UI might also be smaller than that illustrated such as, for example, but including a shorter summary of the recommended workflow. Such a UI might also, or alternately, disappear or hide after a certain period of time has elapsed since it was displayed without user interaction. Other types of UIs can be utilized in other embodiments.

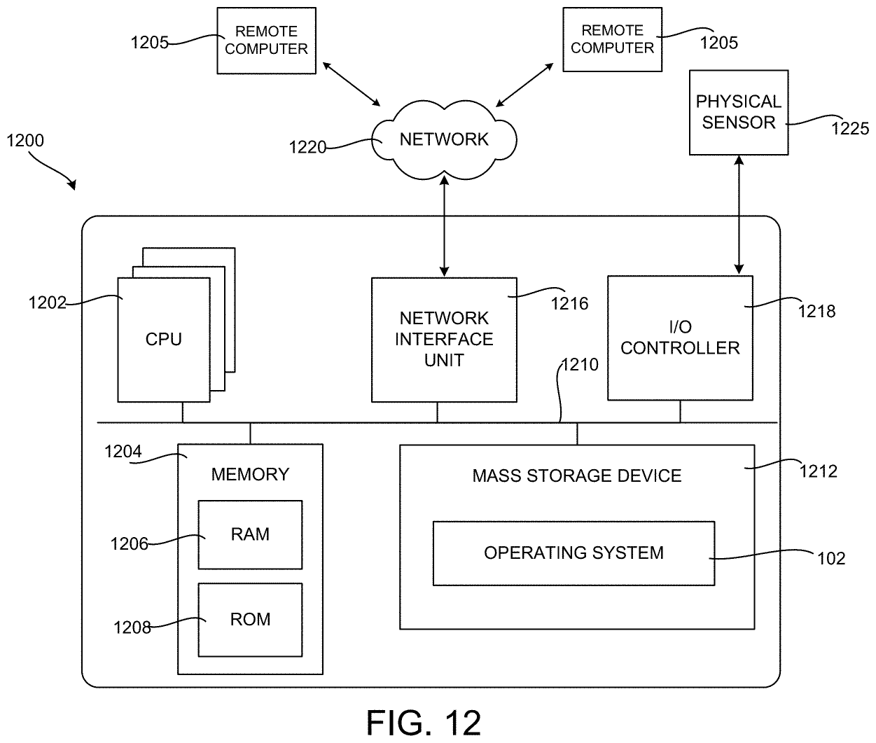

FIG. 12 is a computer architecture diagram showing an illustrative computer hardware and software architecture for a computing device that can implement the various technologies presented herein. In particular, the architecture illustrated in FIG. 12 can be utilized to implement a server computer, mobile phone, an e-reader, a smartphone, a desktop computer, an AR/VR device, a tablet computer, a laptop computer, or another type of computing device. For example, and without limitation, the computer architecture shown in FIG. 12 might be utilized to implement the computing devices shown in FIG. 1 and described above.

The computer 1200 illustrated in FIG. 12 includes a central processing unit 1202 (“CPU”), a system memory 1204, including a random-access memory 1206 (“RAM”) and a read-only memory (“ROM”) 1208, and a system bus 1210 that couples the memory 1204 to the CPU 1202. A basic input/output system (“BIOS” or “firmware”) containing the basic routines that help to transfer information between elements within the computer 1200, such as during startup, can be stored in the ROM 1208. The computer 1200 further includes a mass storage device 1212 for storing an operating system 122, application programs, and other types of programs. The mass storage device 1212 can also be configured to store other types of programs and data.

The mass storage device 1212 is connected to the CPU 1202 through a mass storage controller (not shown) connected to the bus 1210. The mass storage device 1212 and its associated computer readable media provide non-volatile storage for the computer 1200. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 1200.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 1200. For purposes of the claims, the phrase “computer storage medium,” and variations thereof, does not include waves or signals per se or communication media.

According to various configurations, the computer 1200 can operate in a networked environment using logical connections to remote computers 1205 through a network such as the network 1220. The computer 1200 can connect to the network 1220 through a network interface unit 1216 connected to the bus 1210. It should be appreciated that the network interface unit 1216 can also be utilized to connect to other types of networks and remote computer systems such as those shown in FIG. 12 and described below. The computer 1200 can also include an input/output controller 1218 for receiving and processing input from a number of other devices, including a keyboard, mouse, touch input, an electronic stylus (not shown in FIG. 12), or a physical sensor such as a video camera. Similarly, the input/output controller 1218 can provide output to a display screen or other type of output device (also not shown in FIG. 12).

It should be appreciated that the software components described herein, when loaded into the CPU 1202 and executed, can transform the CPU 1202 and the overall computer 1200 from a general-purpose computing device into a special-purpose computing device customized to facilitate the functionality presented herein. The CPU 1202 can be constructed from any number of transistors or other discrete circuit elements, which can individually or collectively assume any number of states. More specifically, the CPU 1202 can operate as a finite-state machine, in response to executable instructions contained within the software modules disclosed herein. These computer-executable instructions can transform the CPU 1202 by specifying how the CPU 1202 transitions between states, thereby transforming the transistors or other discrete hardware elements constituting the CPU 1202.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 1200 in order to store and execute the software components presented herein. It also should be appreciated that the architecture shown in FIG. 12 for the computer 1200, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 1200 might not include all of the components shown in FIG. 12, can include other components that are not explicitly shown in FIG. 12, or can utilize an architecture completely different than that shown in FIG. 12.

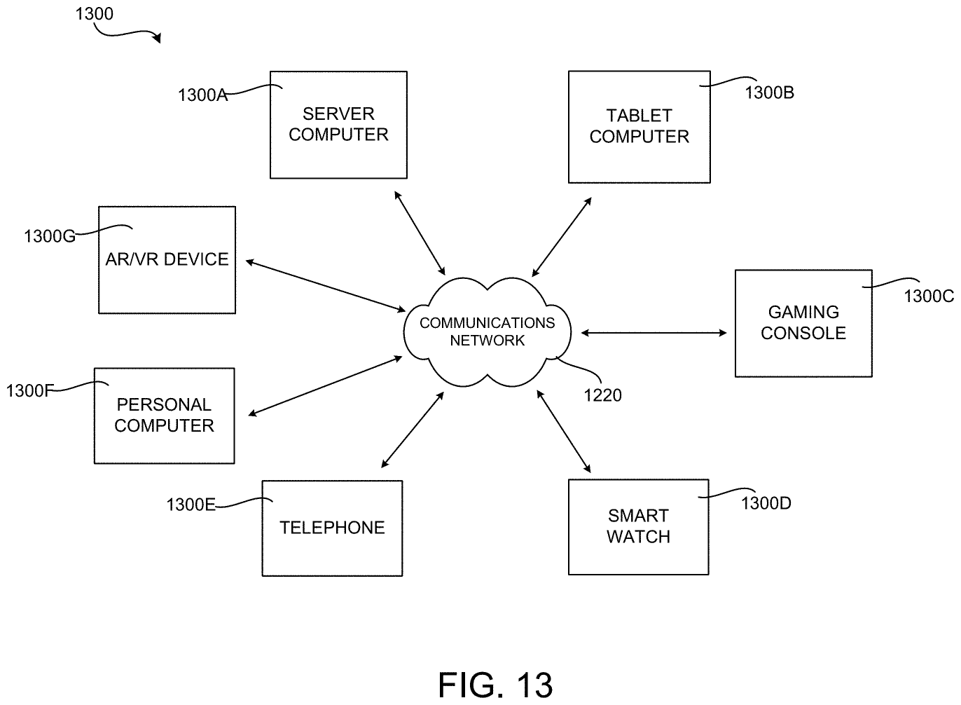

FIG. 13 is a network diagram illustrating a distributed network computing environment 1300 in which aspects of the disclosed technologies can be implemented, according to various embodiments presented herein. As shown in FIG. 13, one or more server computers 1300A can be interconnected via a communications network 1220 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 1300B, a gaming console 1300C, a smart watch 1300D, a telephone 1300E, such as a smartphone, a personal computer 1300F, and an AR/VR device 1300G.

In a network environment in which the communications network 1220 is the Internet, for example, the server computer 1300A can be a dedicated server computer operable to process and communicate data to and from the client computing devices 1300B-130OG via any of a number of known protocols, such as, hypertext transfer protocol (“HTTP”), file transfer protocol (“FTP”), a remote desktop protocol, TCP, UDP, or simple object access protocol (“SOAP”). Additionally, the networked computing environment 1300 can utilize various data security protocols such as secured socket layer (“SSL”) or pretty good privacy (“PGP”). Each of the client computing devices 1300B-1300G can be equipped with an operating system operable to support one or more computing applications or terminal sessions such as a web browser (not shown in FIG. 13), or other graphical user interface (not shown in FIG. 13), or a mobile desktop environment (not shown in FIG. 13) to gain access to the server computer 1300A.

The server computer 1300A can be communicatively coupled to other computing environments (not shown in FIG. 13) and receive data regarding a participating user's interactions/resource network. In an illustrative operation, a user (not shown in FIG. 13) may interact with a computing application running on a client computing device 1300B-1300G to obtain desired data and/or perform other computing applications.

The data and/or computing applications may be stored on the server 1300A, or servers 1300A, and communicated to cooperating users through the client computing devices 1300B-1300G over an exemplary communications network 1320. A participating user (not shown in FIG. 13) may request access to specific data and applications housed in whole or in part on the server computer 1300A. These data may be communicated between the client computing devices 1300B-1300G and the server computer 1300A for processing and storage.

The server computer 1300A can host computing applications, processes and applets for the generation, authentication, encryption, and communication of data and applications, and may cooperate with other server computing environments (not shown in FIG. 13), third party service providers (not shown in FIG. 13), network attached storage (“NAS”) and storage area networks (“SAN”) to realize application/data transactions.

It should also be appreciated that the computing architecture shown in FIG. 13 and the distributed network computing environment shown in FIG. 13 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method for machine learning assisted automation of a workflow, the method comprising: collecting user interaction data on a computing device, the user interaction data defining one or more interactions by a user with one or more features provided by an operating system (OS) executing on the computing device; providing the user interaction data to a machine learning model trained to identify, based at least in part on the user interaction data, a workflow for performing a task; receiving from the machine learning model an indication of the identified workflow for performing the task; and initiating execution of the workflow on the computing device for performing the task.

Clause 2. The computer-implemented method of clause 1, wherein the user interaction data comprises data copied to an OS-provided clipboard by the user.

Clause 3. The computer-implemented method of clauses 1 or 2, wherein the user interaction data comprises data describing one or more search operations performed by the user utilizing an OS-provided search feature.

Clause 4. The computer-implemented method of any of clauses 1-3, wherein the user interaction data comprises data describing one or more applications launched by the user by way of the OS.

Clause 5. The computer-implemented method of any of clauses 1-4, wherein the user interaction data comprises data describing one or more files opened by the user utilizing the OS.

Clause 6. The computer-implemented method of any of clauses 1-5, further comprising responsive to receiving the indication of the identified workflow for performing the task from the machine learning model: presenting a user interface on the computing device, the user interface identifying the workflow; receiving an indication from the user by way of the user interface that the workflow is to be performed; and initiating execution of the workflow on the computing device responsive to receiving the indication from the user by way of the user interface.

Clause 7. The computer-implemented method of any of clauses 1-6, wherein the machine learning model is further configured to identify the workflow based, at least in part, on metadata associated with the user interaction data, the metadata defining one or more of a frequency of occurrence of the interaction of the user with the one or more features provided by the OS, an order of occurrence of the interaction of the user with the one or more features provided by the OS, a location of the computing device at a time of the interaction of the user with the one or more features provided by the OS, or an identity of one or more other users associated with the interaction of the user with the one or more features provided by the OS.

Clause 8. A computer-readable storage medium having computer-executable instructions stored thereupon which, when executed by a computing device, cause the computing device to: observe user interaction with one or more features provided by an operating system (OS) executing on the computing device to collect user interaction data, the user interaction data defining the user interaction with the one or more features provided by the OS; execute a machine learning model on the computing device, the machine learning model trained to identify, based at least in part on the user interaction data, a workflow for performing a task; receive from the machine learning model an indication of an identified workflow for performing the task; and execute the workflow on the computing device to perform the task.

Clause 9. The computer-readable storage medium of clause 8, wherein the user interaction data comprises data copied to an OS-provided clipboard by the user and wherein the workflow comprises a workflow for creating a calendar event from the data copied to the OS-provided clipboard.

Clause 10. The computer-readable storage medium of clauses 8 or 9, wherein the user interaction data comprises data describing one or more searches for a file performed by the user utilizing an OS-provided search feature and wherein the workflow comprises a workflow for adding a file to a recently used files list.

Clause 11. The computer-readable storage medium of any of clauses 8-10, wherein the user interaction data comprises data copied to an OS-provided clipboard by the user and wherein the workflow comprises a workflow for creating a collection containing the data copied to the OS-provided clipboard.

Clause 12. The computer-readable storage medium of any of clauses 8-11, wherein the user interaction data comprises data describing the launching of one or more applications by the user by way of the OS and wherein the workflow comprises a workflow for automatically launching the one or more applications.

Clause 13. The computer-readable storage medium of any of clauses 8-12, having further computer-executable instructions stored thereupon which, when executed by the computing device, cause the computing device to: present a user interface by way of the computing device, the user interface identifying the workflow; receive an indication from the user by way of the user interface that the workflow is to be executed; and cause the workflow to be executed on the computing device responsive to receiving the indication from the user.

Clause 14. The computer-readable storage medium of any of clauses 8-13, wherein the machine learning model is further configured to identify the workflow based, at least in part, on metadata associated with the user interaction data, the metadata defining one or more of a frequency of occurrence of the interaction of the user with the one or more features provided by the OS, an order of occurrence of the interaction of the user with the one or more features provided by the OS, a location of the computing device at a time of the interaction of the user with the one or more features provided by the OS, or an identity of one or more other users associated with the interaction of the user with the one or more features provided by the OS.

Clause 15. The computer-readable storage medium of any of clauses 8-14, wherein the user interaction data comprises data copied to an OS-provided clipboard by the user and wherein the workflow comprises a workflow for initiating a communication session using the data copied to the OS-provided clipboard.

Clause 16. The computer-readable storage medium of any of clauses 8-15, wherein the user interaction data comprises data copied to an OS-provided clipboard by the user and wherein the workflow comprises a workflow for translating the data copied to the OS-provided clipboard.

Clause 17. The computer-readable storage medium of any of clauses 8-16, wherein the user interaction data comprises data copied to an OS-provided clipboard by the user and wherein the workflow comprises a workflow for removing formatting from the data copied to the OS-provided clipboard.

Clause 18. A computing device, comprising: at least one processor; and a computer-readable storage medium having computer-executable instructions stored thereupon which, when executed by the at least one processor, cause the computing device to: observe interaction by a user with one or more features provided by an operating system (OS) executing on the computing device to collect user interaction data, the user interaction data defining the user interaction with the one or more features provided by the OS; execute a machine learning model on the computing device, the machine learning model trained to identify, based at least in part on the user interaction data, a workflow for performing a task; receive from the machine learning model an indication of an identified workflow for performing the task; and execute the workflow on the computing device to perform the task.

Clause 19. The computing device of clause 18, wherein the user interaction data comprises one or more of data copied to an OS-provided clipboard by the user, data describing one or more search operations performed by the user utilizing an OS-provided search feature, data describing one or more applications launched by the user by way of the OS, or data describing one or more files opened by the user utilizing the OS.

Clause 20. The computing device of clauses 18 or 19, wherein the workflow comprises a workflow for creating a calendar event from data copied to an OS-provided clipboard, a workflow for initiating a communication session using data copied to an OS-provided clipboard, a workflow for translating data copied to an OS-provided clipboard, a workflow for removing formatting from data copied to an OS-provided clipboard, a workflow for adding a file to a recently used files list, a workflow for creating a collection containing data copied to the OS-provided clipboard, or a workflow for automatically launching the one or more applications on the computing device.

Clause 21. The computing device of any of clauses 18-20, wherein the computer-readable storage medium has further computer-executable instructions stored thereupon which, when executed by the computing device, cause the computing device to: present a user interface by way of the computing device, the user interface identifying the workflow; receive an indication from the user by way of the user interface that the workflow is to be executed; and cause the workflow to be executed on the computing device responsive to receiving the indication from the user.

Clause 22. The computing device of any of clauses 18-21, wherein the computer-readable storage medium has further computer-executable instructions stored thereupon which, when executed by the computing device, cause the computing device to initiate retraining of the machine learning model responsive to receiving an indication not to execute the workflow by way of the user interface.

Clause 23. The computing device of any of clauses 18-22, wherein the machine learning model is further configured to identify the workflow based, at least in part, on metadata associated with the user interaction data, the metadata defining one or more of a frequency of occurrence of the interaction of the user with the one or more features provided by the OS, an order of occurrence of the interaction of the user with the one or more features provided by the OS, a location of the computing device at a time of the interaction of the user with the one or more features provided by the OS, or an identity of one or more other users associated with the interaction of the user with the one or more features provided by the OS.

Based on the foregoing, it should be appreciated that technologies for machine learning assisted automation of workflows based on observation of user interaction with OS platform features have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method for machine learning assisted automation of a workflow, the method comprising:
collecting user interaction data on a computing device, the user interaction data defining one or more interactions by a user with one or more features provided by an operating system (OS) executing on the computing device;
providing the user interaction data to a machine learning model trained to identify, based at least in part on the user interaction data, a workflow for performing a task;
receiving from the machine learning model an indication of the identified workflow for performing the task; and
initiating execution of the workflow on the computing device for performing the task.

2. The computer-implemented method of claim 1, wherein the user interaction data comprises data copied to an OS-provided clipboard by the user.

3. The computer-implemented method of claim 1, wherein the user interaction data comprises data describing one or more search operations performed by the user utilizing an OS-provided search feature.

4. The computer-implemented method of claim 1, wherein the user interaction data comprises data describing one or more applications launched by the user by way of the OS.

5. The computer-implemented method of claim 1, wherein the user interaction data comprises data describing one or more files opened by the user utilizing the OS.

6. The computer-implemented method of claim 1, further comprising responsive to receiving the indication of the identified workflow for performing the task from the machine learning model:
presenting a user interface on the computing device, the user interface identifying the workflow;
receiving an indication from the user by way of the user interface that the workflow is to be performed; and
initiating execution of the workflow on the computing device responsive to receiving the indication from the user by way of the user interface.

7. The computer-implemented method of claim 1, wherein the machine learning model is further configured to identify the workflow based, at least in part, on metadata associated with the user interaction data, the metadata defining one or more of a frequency of occurrence of the interaction of the user with the one or more features provided by the OS, an order of occurrence of the interaction of the user with the one or more features provided by the OS, a location of the computing device at a time of the interaction of the user with the one or more features provided by the OS, or an identity of one or more other users associated with the interaction of the user with the one or more features provided by the OS.

8. A computer-readable storage medium having computer-executable instructions stored thereupon which, when executed by a computing device, cause the computing device to:
observe user interaction with one or more features provided by an operating system (OS) executing on the computing device to collect user interaction data, the user interaction data defining the user interaction with the one or more features provided by the OS;
execute a machine learning model on the computing device, the machine learning model trained to identify, based at least in part on the user interaction data, a workflow for performing a task;
receive from the machine learning model an indication of an identified workflow for performing the task; and
execute the workflow on the computing device to perform the task.

9. The computer-readable storage medium of claim 8, wherein the user interaction data comprises data copied to an OS-provided clipboard by the user and wherein the workflow comprises a workflow for creating a calendar event from the data copied to the OS-provided clipboard.

10. The computer-readable storage medium of claim 8, wherein the user interaction data comprises data copied to an OS-provided clipboard by the user and wherein the workflow comprises a workflow for initiating a communication session using the data copied to the OS-provided clipboard.

11. The computer-readable storage medium of claim 8, wherein the user interaction data comprises data copied to an OS-provided clipboard by the user and wherein the workflow comprises a workflow for translating the data copied to the OS-provided clipboard.

12. The computer-readable storage medium of claim 8, wherein the user interaction data comprises data copied to an OS-provided clipboard by the user and wherein the workflow comprises a workflow for removing formatting from the data copied to the OS-provided clipboard.

13. The computer-readable storage medium of claim 8, wherein the user interaction data comprises data describing one or more searches for a file performed by the user utilizing an OS-provided search feature and wherein the workflow comprises a workflow for adding a file to a recently used files list.

14. The computer-readable storage medium of claim 8, wherein the user interaction data comprises data copied to an OS-provided clipboard by the user and wherein the workflow comprises a workflow for creating a collection containing the data copied to the OS-provided clipboard.

15. The computer-readable storage medium of claim 8, wherein the user interaction data comprises data describing the launching of one or more applications by the user by way of the OS and wherein the workflow comprises a workflow for automatically launching the one or more applications.

16. A computing device, comprising:
at least one processor; and
a computer-readable storage medium having computer-executable instructions stored thereupon which, when executed by the at least one processor, cause the computing device to:
observe interaction by a user with one or more features provided by an operating system (OS) executing on the computing device to collect user interaction data, the user interaction data defining the user interaction with the one or more features provided by the OS;
execute a machine learning model on the computing device, the machine learning model trained to identify, based at least in part on the user interaction data, a workflow for performing a task;
receive from the machine learning model an indication of an identified workflow for performing the task; and
execute the workflow on the computing device to perform the task.

17. The computing device of claim 16, wherein the user interaction data comprises one or more of data copied to an OS-provided clipboard by the user, data describing one or more search operations performed by the user utilizing an OS-provided search feature, data describing one or more applications launched by the user by way of the OS, or data describing one or more files opened by the user utilizing the OS.

18. The computing device of claim 16, wherein the workflow comprises a workflow for creating a calendar event from data copied to an OS-provided clipboard, a workflow for initiating a communication session using data copied to an OS-provided clipboard, a workflow for translating data copied to an OS-provided clipboard, a workflow for removing formatting from data copied to an OS-provided clipboard, a workflow for adding a file to a recently used files list, a workflow for creating a collection containing data copied to the OS-provided clipboard, or a workflow for automatically launching the one or more applications on the computing device.

19. The computing device of claim 16, wherein the computer-readable storage medium has further computer-executable instructions stored thereupon which, when executed by the computing device, cause the computing device to:
present a user interface by way of the computing device, the user interface identifying the workflow;
receive an indication from the user by way of the user interface that the workflow is to be executed; and
cause the workflow to be executed on the computing device responsive to receiving the indication from the user.

20. The computing device of claim 16, wherein the computer-readable storage medium has further computer-executable instructions stored thereupon which, when executed by the computing device, cause the computing device to initiate retraining of the machine learning model responsive to receiving an indication not to execute the workflow by way of the user interface.
